(19) United States
(12) Patent Application Publication
(10) Pub. No.: US 2026/0352484 A1
(43) Pub. Date: Nov. 5, 2026

(54) PULL BASED MULTI FACTOR AUTHENTICATION

(71) Applicant: Intuition Machines, Inc., Miami, FL (US)

(72) Inventor: Eli-Shaoul Khedouri, Miami, FL (US)

(21) Appl. No.: 19/262,461

(22) Filed: Jul. 8, 2025

Related U.S. Application Data
(60) Provisional application No. 63/798,688, filed on May 2, 2025.

(51) Int. Cl. H04L 9/32

(52) U.S. Cl. CPC H04L 9/3247; H04L 9/3213; H04L 9/3236

(57) ABSTRACT

Disclosed are a computer-implemented method and system for performing pull-based multi-factor authentication (MFA), wherein a user originates a short message containing a stateless, cryptographically signed token to authenticate with a relying-party (RP) service. Before generating the token, the system receives the user's phone number and queries a carrier information service to obtain metadata including carrier identity and SIM-change status. Using this information, the system generates a signed token encoding the phone number, carrier ID, RP identifier, and an expiration time. Upon receiving the SMS, the system validates the token by verifying its digital signature without referencing the server-side session state. The user is authenticated based on successful token validation and a device-risk score below a defined threshold. The present system enables secure, and low-latency authentication while mitigating SIM-swap fraud, SMS toll fraud, and token replay attacks.

### PRIORITY CLAIM

This application claims the benefit of U.S. Provisional Patent Application No. 63/798,688, filed on May 2, 2025, titled “PULL BASED MULTI FACTOR AUTHENTICATION,” the entire contents of which are incorporated herein by reference.

### BACKGROUND

Multi-factor authentication has become a widely adopted security measure in online services to protect against unauthorized access. A common approach in commercial MFA systems involves a “forward SMS” mode, in which a relying party (RP) transmits a one-time password (OTP) via SMS to the user's registered phone number. The user then enters the received OTP to complete the authentication process. While this method is simple and familiar to users, it is increasingly vulnerable to various attack vectors, including SIM-swap-based account takeovers (ATO), SMS pumping and toll fraud, and man-in-the-middle attacks.

To address some of these weaknesses, prior systems have proposed reverse or reply-based SMS authentication methods. For example, certain disclosures such as KR 20180109027A (Method and System for Providing Certification by using Reverse Direction Reply Message, and Record Medium) and U.S. Pat. No. 7,702,898 B2 (Method for authenticating and verifying SMS communications) teach schemes where the user responds to a server-generated challenge or echoes an encrypted payload via SMS. However, these systems and methods retain significant limitations. Specifically, such systems often (i) generate the authentication code before verifying the subscriber's phone number, (ii) rely on maintaining server-side session state to match inbound messages, (iii) expose public-facing inbound numbers susceptible to abuse through toll fraud schemes, and (iv) fail to incorporate device-level risk signals or carrier-provided indicators such as SIM-change or number-porting events.

There remains a need in the art for an MFA mechanism that mitigates the vulnerabilities of forward-SMS models while improving upon the limitations of prior reverse-SMS techniques through stateless operation, improved fraud resistance, and integration of modern device and carrier risk analytics.

### SUMMARY OF THE INVENTION

According to an embodiment of the disclosure, a computer-implemented method for authenticating a user of a relying-party (RP) service is described. The method includes a step of receiving, by a computer, a phone number before generating an authentication code from a client device of the user from a client device of the user. The method includes a step of querying, by the computer, a carrier information service using the phone number to obtain a carrier identity and SIM-change data associated with the user. The method includes a step of generating, by the computer, based on the phone number, the carrier identity, a relying-party identifier (RP-ID), an expiry time, and a signed token (stateless token) that encodes the values. The method includes a step of selecting, by the computer, a message destination address restricted to the identified carrier. The method includes a step of transmitting, by the computer, instructions to the client device to send the signed token to the destination address. The method includes a step of receiving, by the computer, an SMS message from the client device containing the signed token. The method includes a step of validating, by the computer, the signed token without referencing any pre-existing session state, by verifying a digital signature associated with the token. The method includes a step of authenticating, by the computer, the user in response to successful validation and a device-risk score below a predefined threshold.

In an aspect, the method includes a step of encoding, by the computer, the signed token as a base-36 alphanumeric code of 12 or fewer characters, suitable for manual entry by the user.

In an aspect, the method includes a step of adjusting, by the computer, the device-risk score by applying a penalty when the SIM-change data indicates a SIM change occurred within a configurable time window.

In an aspect, the method includes a step of rate-limiting, by the computer, inbound authentication attempts by enforcing a threshold defined as no more than n SMS messages containing signed tokens from a single MSISDN or device within a rolling time window of t minutes, wherein n and t are dynamically configurable.

In an aspect, the method includes steps of calculating, by the computer, a preliminary device-risk score; when the preliminary score lies between a first threshold and a second threshold (higher), prompting, by the computer, the user with a CAPTCHA challenge before rendering an SMS URI; and generating, by the computer, the SMS URI only upon successful completion of the CAPTCHA.

In an aspect, the method includes steps of inserting, by the computer, a hash of each successfully validated signed token into a probabilistic data structure or persistent database for a duration not less than the token's expiry interval; and rejecting, by the computer, any subsequent SMS message that yields a matching hash in the data structure, thereby preventing token replay.

In an aspect, the method includes steps of determining, by the computer, a preferred phone number for the user based on at least one of: a stored account record, user input, or a geolocation-based selection; constructing, by the computer, a Uniform Resource Identifier (URI) conforming to the “sms:” scheme, encoding the destination phone number and the signed token in the message body; and causing the client device, in response to user interaction with a graphical interface element, to launch a messaging application using the URI.

According to an embodiment of the disclosure, a computer system for authenticating a user of a relying-party (RP) service is described. The computer system includes a memory and a processor set. The memory stores machine-readable instructions pertaining to user authentication. The processor set is configured to: receive a phone number before generating an authentication code from a client device of the user; query a carrier information service using the phone number to obtain a carrier identity and SIM-change data associated with the user; generate based on the phone number, the carrier identity, a relying-party identifier (RP-ID), an expiry time, a signed token that encodes the values; select a message destination address restricted to the identified carrier; transmit instructions to the client device to send the signed token to the destination address; receive an SMS message from the client device containing the signed token; validate the signed token without referencing any pre-existing session state, by verifying a digital signature associated with the token; and authenticate the user in response to successful validation and a device-risk score below a predefined threshold.

In an aspect, the processor set is configured to encode the signed token as a base-36 alphanumeric code of 12 or fewer characters, suitable for manual entry by the user.

In an aspect, the processor set is configured to adjust the device-risk score by applying a penalty when the SIM-change data indicates a SIM change occurred within a configurable time window.

In an aspect, the processor set is configured to rate-limit inbound authentication attempts by enforcing a threshold defined as no more than N SMS messages containing signed tokens from a single MSISDN within a rolling time window of T minutes, wherein N and T are dynamically configurable.

In an aspect, the processor set is configured to: calculate a preliminary device-risk score; when the preliminary score lies between a first threshold and a second threshold, prompt the user with a CAPTCHA challenge before rendering an SMS URI; and generating the SMS URI only upon successful completion of the CAPTCHA.

In an aspect, the processor set is configured to: insert a hash of each successfully validated signed token into a probabilistic data structure or persistent database for a duration not less than the token's expiry interval; and reject any subsequent SMS message that yields a matching hash in the data structure, thereby preventing token replay.

In an aspect, the processor set is configured to: determine a preferred phone number for the user based on at least one of: a stored account record, user input, and a geolocation-based selection; construct a Uniform Resource Identifier (URI) conforming to the “sms:” scheme, encoding the destination phone number and the signed token in the message body; and cause the client device in response to user interaction with a graphical interface element, to launch a messaging application using the URI.

In an aspect, the message destination address is a Home Network Identifier (HNI)-restricted shortcode routable only within the user's home carrier network.

In an aspect, the signed token is generated using a hash-based stateless signature algorithm that provides at least 80 bits of cryptographic security.

In an aspect, the device-risk score is computed using one or more of: browser fingerprint data; hardware attestation signals; and metadata bound into the signed token.

According to an embodiment of the disclosure, a computer program product comprising at least one non-transitory computer-readable storage medium having computer-executable program code instructions stored therein is described. The computer-executable program code instructions comprising program code instructions to: receive a phone number before generating an authentication code from a client device of the user from a client device of the user; query a carrier information service using the phone number to obtain a carrier identity and SIM-change data associated with the user; generate based on the phone number, the carrier identity, a relying-party identifier (RP-ID), an expiry time, a signed token that encodes the values; select a message destination address restricted to the identified carrier; transmit instructions to the client device to send the signed token to the destination address; receive an SMS message from the client device containing the signed token; validate the signed token without referencing any pre-existing session state, by verifying a digital signature associated with the token; and authenticate the user in response to successful validation and a device-risk score below a predefined threshold.

Accordingly, one advantage of the present invention is that it provides a system that uses codes sent over mediums like Short Message Service (SMS) in which the user transmits, rather than receives, the one-time verification code.

### BRIEF DESCRIPTION OF THE DRAWINGS

The features and advantages of the present disclosure will be more fully understood with reference to the following detailed description when taken in conjunction with the accompanying figures, wherein:

FIG. 1 depicts a diagram that illustrates a computing environment for authenticating a user of a relying-party (RP) service, in accordance with an embodiment of the disclosure.

FIG. 2 depicts a diagram that illustrates a network environment for authenticating a user of a relying-party (RP) service, in accordance with an embodiment of the disclosure.

FIG. 3 illustrates a system architecture (IdP, verifier microservice, carrier gateway, relying party), in accordance with an embodiment of the disclosure.

FIG. 4 illustrates a message-sequence chart for enrollment and for subsequent authentications, in accordance with an embodiment of the disclosure.

FIG. 5 illustrates a structure of the stateless code (header, payload, signature, checksum), in accordance with an embodiment of the disclosure.

FIG. 6 illustrates a risk-scoring engine combining carrier signals and device-fingerprint vectors, in accordance with an embodiment of the disclosure.

FIG. 7 illustrates a flowchart that illustrates a computer-implemented method for authenticating a user of a relying-party (RP) service, in accordance with an embodiment of the disclosure.

### DETAILED DESCRIPTION

The present invention relates to electronic authentication and, more particularly, to an improved system and method for multi-factor authentication (MFA) in which the user initiates the authentication message—such as a short message service (SMS) or similar channel (e.g., WhatsApp) to invert the conventional MFA flow. This reverse architecture eliminates the need for outbound messaging from the relying party (RP), significantly reducing infrastructure costs and blocking SMS-based abuse vectors such as toll fraud and SMS-pumping attacks.

In one embodiment, the system acquires the user's phone number in advance of code generation. This enables immediate querying of carrier metadata (e.g., HLR or MNP lookups) to extract fraud signals and select routing parameters. A cryptographically signed, stateless token is generated, encoding a set of parameters including the phone number, carrier identifier, relying party identifier (RP-ID), nonce, and expiration time. The resulting token, which may be a compact base-32 or base-36 string, can be verified without reference to any server-side session state, thus supporting low-latency validation.

To further mitigate fraud, the system may issue carrier-scoped destination addresses. These include short codes or virtual numbers that are routable only within the user's home network (e.g., via HNI-restricted identifiers or intra-carrier USSD aliases), effectively blocking toll fraud across mobile networks.

The signed token may be bound to a set of telemetry signals that are collected at login such as device fingerprints, browser characteristics, secure hardware attestations (e.g., WebAuthn, SafetyNet, or DeviceCheck), and SIM-swap or port-out indicators derived from GSMA or 3GPP feeds. These inputs are evaluated by a risk engine to determine whether authentication should proceed or be escalated (e.g., via step-up challenges).

Unlike traditional forward-SMS MFA, the user bears the cost of originating the SMS, reversing the toll-fraud incentive structure, and eliminating unsolicited messages. Optional pre-validation of the user's carrier status, dynamic token expiration, and replay resistance mechanisms further enhance resilience and reduce abuse.

This architecture enables substantial performance and cost benefits: it reduces outbound SMS traffic by over 99%, minimizes the load on the carrier's SMS infrastructure, and cuts authentication latency from 250 ms to under 2 ms by eliminating session lookups and relying solely on stateless token validation.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” may be tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. In an embodiment, the storage could be local to the room, local to the hospital or hospital system, or hosted on a third-party cloud platform. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

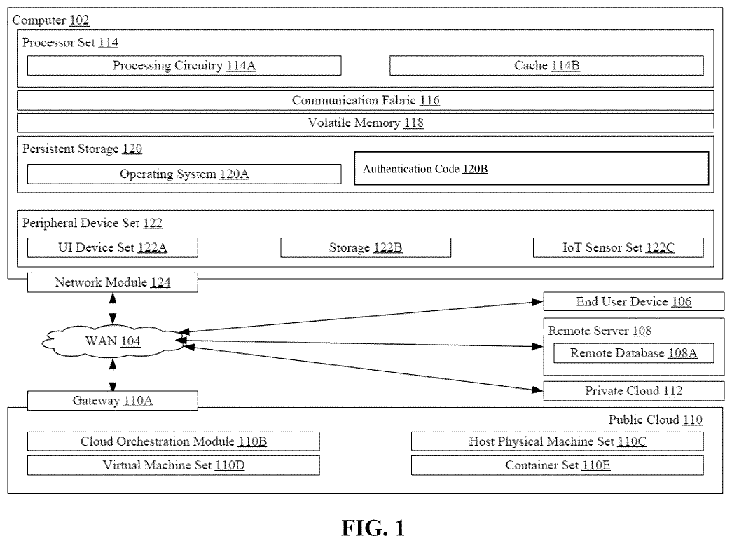

FIG. 1 depicts a diagram that illustrates a computing environment 100 for authenticating a user of a relying-party (RP) service, in accordance with an embodiment of the disclosure. With reference to FIG. 1, there is shown a computing environment 100 that contains an example of an environment for the execution of at least some of the computer code involved in performing the disclosed methods, such as an authentication code 120B. In addition to the authentication code 120B, computing environment 100 includes, for example, a computer 102, a wide area network (WAN) 104, an end-user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the generation of authentication code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

Computer 102 may take the form of a desktop computer, a laptop computer, a single-board computer, an embedded system, a microcontroller, a tablet computer, a smartphone, a smartwatch or other wearable computer, a mainframe computer, a quantum computer, a camera, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors or camera image processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with GPU RAM, qubits, and performing quantum computing.

Computer readable program instructions are typically loaded onto the computer 102 to cause a series of operations to be performed by the processor set 114 of the computers 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods may be stored in the dynamic modification of the authentication code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 118 may be type of volatile memory now known or to be developed in the future. Examples include dynamic type random access memory (RAM) or static type RAM. Typically, the volatile memory 118 is characterized by a random access, but this is not required unless affirmatively indicated. In computer 102, the volatile memory 118 is located in a single package and is internal to computer 102, but alternatively or additionally, the volatile memory 118 may be distributed over multiple packages and/or located externally with respect to computer 102.

The persistent storage 120 may be form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the generation of authentication code 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. Storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 may be any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 may be any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 may be any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 may be computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. Virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. Gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

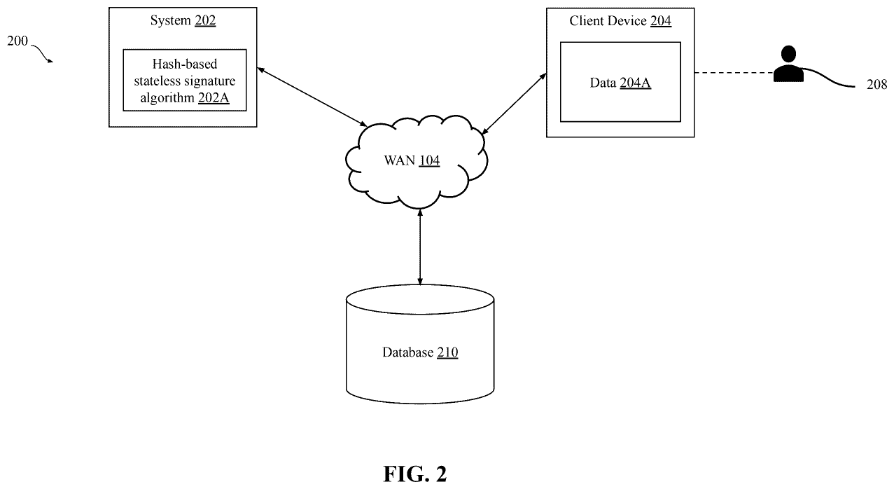

FIG. 2 depicts a diagram that illustrates a network environment 200 for authenticating a user of a relying-party (RP) service, in accordance with an embodiment of the disclosure. FIG. 2 is explained in conjunction with elements from FIG. 1. With reference to FIG. 2, there is shown a diagram of a network environment 200. The network environment 200 includes a computer system (hereinafter referred to as system 202), and a client device 204. The system 202 further includes a hash-based stateless signature algorithm 202A. There is further shown a database 210. The network environment 200 further includes entity 208 associated with the client device 204 or a user device. The network environment 200 further includes the WAN 104 of FIG. 1. In an embodiment of the disclosure, the client device 204 may be an exemplary embodiment of the EUD 106. Similarly, computer system 202 may be an embodiment of computer 102 in FIG. 1. Examples of entity 208 include but are not limited to an administrator. In an embodiment, the End User Device (EUD) 106 is configured as a computing system utilized by a human operator, to access, view, and potentially control or interface with the various components of the system. The EUD 106 may be implemented in any form factor compatible with the computing architecture described in connection with computer 102 or system 202.

System 202 may include suitable logic, circuitry, interfaces, and/or code that may be configured for authenticating a user of a relying-party (RP) service. System 202 is configured to receive a phone number before generating an authentication code from a client device of the user from a client device of the user. System 202 is configured to query a carrier information service using the phone number to obtain a carrier identity and SIM-change data associated with the user. System 202 is configured to generate based on the phone number, the carrier identity, a relying-party identifier (RP-ID), an expiry time, and a signed token that encodes said values. System 202 is configured to select a message destination address restricted to the identified carrier.

System 202 is configured to transmit instructions to the client device to send the signed token to the destination address. System 202 is further configured to receive an SMS message from the client device containing the signed token. System 202 is configured to validate the signed token without referencing any pre-existing session state, by verifying a digital signature associated with the token. System 202 is configured to authenticate the user in response to successful validation and a device-risk score below a predefined threshold. As used herein, a “predefined threshold” refers to a numerical risk score value, for example, within a range of 1 to 100, which may be configured or set by a system administrator. In some embodiments, system 202 is configured to encode the signed token as a base-36 alphanumeric code of 12 or fewer characters. In some embodiments, system 202 is configured to adjust the device-risk score by applying a penalty when the SIM-change data indicates a SIM change occurred within a configurable time window. In some embodiments, system 202 is configured to rate-limit inbound authentication attempts by enforcing a threshold defined as no more than N SMS messages containing signed tokens from a single MSISDN within a rolling time window of T minutes, wherein N and T are dynamically configurable. In some embodiments, system 202 is configured to calculate a preliminary device-risk score.

In some embodiments, system 202 is configured to when the preliminary score lies between a first threshold and a second threshold, prompt the user with a CAPTCHA challenge before rendering an SMS URI. In some embodiments, system 202 is configured to generate the SMS URI only upon successful completion of the CAPTCHA. In some embodiments, system 202 is configured to insert a hash of each successfully validated signed token into a probabilistic data structure or persistent database for a duration not less than the token's expiry interval. In some embodiments, system 202 is configured to reject any subsequent SMS message that yields a matching hash in the data structure, thereby preventing token replay. In some embodiments, system 202 is configured to determine a preferred phone number for the user based on at least one of: a stored account record, user input, and a geolocation-based selection. In some embodiments, system 202 is configured to construct a Uniform Resource Identifier (URI) conforming to the “sms:” scheme, encoding the destination phone number and the signed token in the message body. In some embodiments, system 202 is configured to cause the client device in response to user interaction with a graphical interface element, to launch a messaging application using the URI. In some embodiments, the message destination address is a Home Network Identifier (HNI)-restricted shortcode routable only within the user's home carrier network. In some embodiments, the signed token is generated using a hash-based stateless signature algorithm that provides at least 80 bits of cryptographic security. In some embodiments, the device-risk score is computed using one or more of: browser fingerprint data; hardware attestation signals; and metadata bound into the signed token.

In an embodiment, the examples of the computer system 202 may include but are not limited to, a server, a computing device, a virtual computing device, a mainframe machine, a computer workstation, a smartphone, a camera, a cellular phone, a mobile phone, a gaming device, or a consumer electronic (CE) device.

The user device 204 may include suitable logic, circuitry, interfaces, and/or code that may enable users to interact with the system 202. Examples of the user device 204 may include, but are not limited to, a computing device, a mainframe machine, a server, a computer work-station, a smartphone, a camera, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities.

The display screen may include suitable logic, circuitry, and interfaces that may be configured to render an output generated by the system 202. In some embodiments of the disclosure, the display screen may be an external display device associated with the first user device 204 and the second user device 206. The display screen may be a touch screen which may enable entity 208A to interact via the display screen. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electrochromic display, or a transparent display. In some embodiments of the disclosure, the display screen may be realized through several known technologies such as, but are not limited to, at least one of a liquid Crystal Display (LCD) display, a Light Emitting Diode (LED) display, a plasma display, or an Organic LED (OLED) display technology.

In an embodiment, the algorithmic model 202A may correspond to a computer-based system or software that exhibits characteristics commonly associated with human intelligence. The algorithmic model 202A may be designed to perform tasks that typically require human intelligence, such as problem-solving, learning, reasoning, perception, understanding natural language, and decision-making. AI systems can range from simple rule-based programs to sophisticated, self-learning systems.

The algorithmic model 202A may be a sophisticated piece of software that leverages natural language processing (NLP) and machine learning processes to understand, generate, and manipulate human language. For example, the algorithmic model 202A may correspond to a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction.

In an embodiment, the database 210 corresponds to an organized collection of data that may be stored and accessed electronically from a computer system (such as the system 202). The database 210 is configured to manage, store, retrieve, and update data efficiently. In an exemplary implementation, the structure of the database 210 typically involves tables, records, and fields that can be managed through various database management systems (DBMS). Examples of database 210 include but are not limited to, a relational database, a Non-Structured Query Language (SQL) database, a hierarchical database, a network database, a transactional database, a data warehouse, and a distributed database. In an embodiment, the database 210 is configured to store the data 204A associated with the user device 204 which may include the operating system data, software application data, and software application version data. Further, database 210 stores captured images that may be used to train the algorithmic model 202A.

In implementation, the system supports user enrollment through a flow in which the relying party (RP) either already possesses the user's phone number or acquires it interactively. In this “known number” flow, the RP obtains the user's mobile number (MSISDN) via a pre-existing account record, an API query, or direct user input through a browser or mobile application interface. Once the MSISDN is available, the verifier component may optionally perform a Home Location Register (HLR) or Mobile Number Portability (MNP) lookup to retrieve carrier-specific metadata. This carrier metadata may include a carrier identifier, the timestamp of the most recent SIM change, and a roaming status indicator. These attributes are useful for risk scoring and routing decisions.

The verifier then generates a cryptographically signed, stateless token using a set of fields such as the user's phone number, carrier ID, relying-party ID (RP-ID), issuance timestamp, and a random nonce. These values are concatenated and signed using the verifier's private key (e.g., Ed25519 or SPHINCS+), with the resulting signature truncated to, for example, 48 bits. The final token may be encoded using base-36 into a short alphanumeric string—e.g., a 12-character token suitable for use in SMS. Because the token is self-contained and cryptographically verifiable, the system can operate without maintaining a server-side state between token issuance and validation. Additional metadata may be embedded in the token to support features such as time-bound validity, session binding, and flow-specific scoping.

The system then selects a destination number based on the user's serving network, as determined from the carrier lookup. Specifically, a virtual number or operator-bound short code is selected from a pool that is routable only within the subscriber's home carrier network. This carrier-scoped routing strategy protects against SMS pumping and toll fraud by preventing messages from being misused across networks.

The user interface then instructs the user to send the token to the selected number. For example, the UI may display: “Text AB4J-Q79L-P2 to 57777 within 2 minutes,” or it may render a “Send Code” button that pre-fills the mobile device's messaging application with the destination number and message body.

In a variant of this flow, the system supports a one-click user experience by returning a secure messaging URI after token generation. The URI may take the form of “Text AB4J-Q79L-P2 to 57777 within 2 minutes.” or a similar structure, depending on the platform. The RP embeds this URI in a button or clickable link in the web or app interface. Upon user activation, the device launches the default messaging app with the token and recipient pre-filled. On platforms that support it, such as Android ‘intent:!!’ URIs or ‘sms:!!’ schemes with auto-send flags, the message can be sent automatically without further user interaction and subject to operating system policies and user permissions. This approach minimizes friction, enabling seamless authentication initiation while maintaining the security benefits of a user-originated message.

An exemplary authentication flow will now be described.

In one embodiment of the disclosed system, the authentication process begins when the user transmits an SMS message containing a signed token to a designated destination address. This address, which may be a carrier-scoped shortcode or virtual number, routes the message internally through the mobile network infrastructure to a carrier-integrated gateway under control or accessible by the verifier.

Upon receipt of the inbound SMS message, the gateway extracts the token from the message body and forwards it to the verifier service. The verifier then performs validation of the token by verifying its cryptographic signature and expiration timestamp. This verification is performed in a stateless manner which means that no server-side session or database lookup is required to validate the token's authenticity. The token itself is self-verifying, containing all necessary information in a signed and encoded format.

After token validation, the verifier optionally retrieves real-time contextual data associated with the user's authentication session, such as browser telemetry or client metadata from a concurrent web session initiated by the user. This contextual data may include a browser token, a stable device identifier (e.g., a hashed hardware ID), or a session cookie. The verifier may also compare the current device fingerprint with a previously observed fingerprint associated with the same MSISDN or account.

Additionally, the verifier may consult previously obtained carrier metadata to determine if the user's SIM card has been recently replaced or ported. For example, if the SIM-change timestamp falls within a configurable threshold window (e.g., less than 72 hours before the request), the system increases the risk weighting for the current authentication attempt.

A risk engine combines these inputs to calculate an overall risk score. If the computed risk score falls below a defined threshold, the system returns a “PASS” decision, indicating successful authentication. If the risk score exceeds the threshold, the verifier may initiate a secondary authentication process such as a step-up challenge delivered via push notification, or voice call, or may deny the authentication attempt entirely based on policy.

An exemplary Anti-SIM-Swap and account-takeover defense will now be described.

To enhance protection against SIM-swap fraud and unauthorized account takeover, the disclosed system optionally incorporates multiple defense mechanisms at the authentication stage.

In one embodiment, the verifier may query real-time feeds provided by mobile network operators or industry associations such as the GSMA Threat Intelligence Sharing and Analysis Center (T-ISAC) to determine whether the user's mobile number has undergone a recent SIM change or port-out event. If a mismatch is detected between the expected subscriber profile and the feed data, the system may apply a penalty to the authentication risk score, increasing the likelihood of step-up authentication or outright denial of access.

In another embodiment, the system may require a valid attested device fingerprint for silent or frictionless authentication. The device fingerprint may be derived from hardware identifiers, secure enclave attestations (e.g., Android SafetyNet or Apple DeviceCheck), and browser or operating system metadata. If the entropy of the presented device fingerprint falls below a configurable threshold indicating a low-confidence or spoofed environment. The system may prompt the user to complete a higher-assurance authentication challenge, such as a CAPTCHA or biometric verification.

Additionally, when the user is roaming, the system may enforce a constraint that the inbound SMS used for authentication must originate from a known and verified cell sector corresponding to the subscriber's Mobile Country Code (MCC) and Mobile Network Code (MNC). This information may be verified using signaling data provided by the 3GPP Service Capability Exposure Function (SCEF), ensuring that the message is sent from a legitimate roaming context. This constraint further mitigates risk by blocking spoofed SMS submissions from foreign or untrusted sources.

These layered defenses collectively improve the system's ability to detect and resist sophisticated account takeover attempts involving number reassignments, device emulation, and cross-border fraud vectors.

The present disclosure further describes toll-fraud mitigation mechanisms. The disclosed authentication system is architected to inherently resist SMS-based toll fraud, a common attack vector in traditional forward-SMS multi-factor authentication (MFA) schemes.

In contrast to conventional models, the present system eliminates the need for forward SMS traffic that is, no one-time passcodes (OTPs) are transmitted from the server or relying party (RP) to the user's device. Instead, the user originates the authentication message, typically by sending an SMS containing a cryptographically signed token to a carrier-specific destination number. As a result, attackers are unable to monetize fraudulent requests by triggering high volumes of downstream SMS messages, effectively removing the economic incentive for SMS pumping or toll fraud.

To further protect against automated abuse, the system may enforce an optional rate-limiting mechanism. For example, the system may restrict the number of valid SMS token originations to a maximum of five (5) per 15-minute rolling window per mobile subscriber identity (MSISDN). This policy is designed to prevent brute-force or credential-stuffing attacks, where an attacker attempts to authenticate multiple accounts using stolen or guessed credentials in rapid succession.

Additionally, the system binds each generated authentication code to a specific relying party identifier (RP-ID). During token validation, the RP-ID extracted from the signed token is compared to the RP context in which the authentication request is received. If the identifiers do not match, the token is rejected. This binding prevents an attacker from reusing a single token across multiple merchants or services.

These combined features such as elimination of server-initiated SMS, rate limiting, and RP-specific code binding provide strong resistance to toll fraud and improve the overall security and cost-efficiency of the authentication infrastructure.

Exemplary privacy and accessibility enhancements will now be described.

The disclosed system incorporates privacy-preserving mechanisms and accessibility accommodations to ensure secure, inclusive authentication across a wide range of user contexts.

In one embodiment, user privacy is enhanced by the system's use of stateless, cryptographically signed tokens. Specifically, only a compact digital signature generated as a digest of selected non-sensitive parameters is transmitted from the user's device during the authentication process. Because no raw user data such as the mobile subscriber number (MSISDN), device identifiers, or session attributes is transmitted in plaintext, the system ensures that no personally identifiable information (PII) is exposed in transit. This design choice minimizes the risk of data leakage or interception and aligns with privacy-by-design principles.

In another embodiment, the system improves accessibility by supporting destination numbers that are carrier-scoped or regionally scoped. These destination addresses may include virtual numbers, shortcodes, or intra-network routing aliases that are resolvable solely within a user's home mobile network or within a specific geographic region. This feature is particularly beneficial for users who do not have mobile data plans, as it allows authentication via standard SMS messaging without requiring access to internet-based services. By respecting constraints imposed by mobile network operators and accommodating users in low-connectivity environments, the system ensures broad accessibility while maintaining security and fraud resistance.

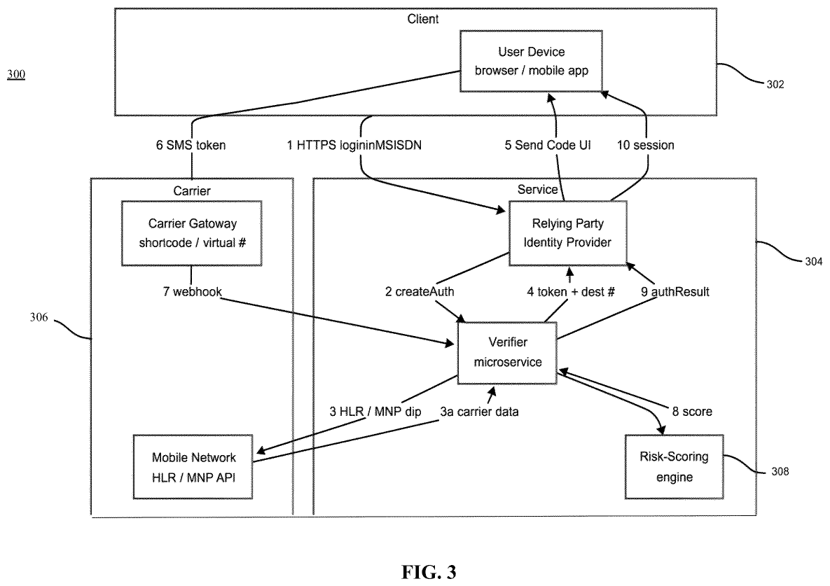

FIG. 3 illustrates a system architecture (IdP, verifier microservice, carrier gateway, relying party) 300, in accordance with an embodiment of the disclosure. The system architecture 300 includes three main functional domains. The first domain is client 302 which includes a user device which is a browser or mobile app used by the user to initiate the login request (1) and ultimately transmit the SMS containing the authentication token (6). The user interface displays the “Send Code” option (5) and receives the final session confirmation (10).

The second domain is service 304 which is the Relying Party/Identity Provider (RP/IdP) to receive the initial HTTPS login request containing the MSISDN (user's phone number) and initiates the authentication process by calling the verifier microservice (2). Service 304 is further configured to receive the generated token and carrier-specific destination number (4) from the verifier, and returns UI instructions to the user. Service 304 ultimately receives the authentication result (9) from the verifier and establishes the session (10). Service 304 also provides a verifier microservice in which the central component is responsible for: Performing a mobile number portability (MNP) or HLR lookup via the Mobile Network (3), Generating a stateless, signed token based on the subscriber and carrier data (3a), Assigning a secure destination number (4), Verifying the received token upon webhook callback (7), and Scoring the risk using device and carrier data (8) before sending an authentication decision (9) to the RP.

The third domain is carrier 306 in which the carrier gateway receives the SMS token from the user (6) and invokes a webhook (7) to pass the token to the verifier microservice. Mobile Network/HLR or MNP API: Provides carrier metadata, such as network ID, porting status, and SIM-change history (3a), used in fraud detection and destination routing.

Further, a risk-scoring engine 308 is used by the verifier microservice to evaluate the trustworthiness of the user session using a combination of device fingerprints, SIM-swap history, and behavioral data (8). This architecture ensures secure, stateless, and fraud-resistant authentication by requiring the user to originate the SMS message containing the signed token, thereby reducing common vulnerabilities associated with conventional forward-SMS MFA methods.

In one non-limiting embodiment, a risk-scoring engine may be configured to compute a composite “Overall Risk Score” by assigning numerical values to various input signals and calculating a weighted sum of those values. Once the Overall Risk Score is determined, the engine may compare the result against one or more predefined thresholds to help determine the appropriate authentication decision.

An exemplary risk-scoring algorithm may operate as follows. The process could begin by initializing a base risk score of zero at the start of a session. Subsequently, input signals may be evaluated, and numerical penalties or additions applied to the score based on predefined criteria. For instance, a SIM-Change Age Score may be computed based on the recency of a SIM card change. If the SIM change occurred within the last 24 hours, 50 points might be added; if within the last 72 hours, 20 points might be added; and if no recent SIM change is detected, no points may be added.

Device fingerprint signals may also be assessed. If the device fingerprint matches a trusted, historical fingerprint for the user's account and passes hardware attestation such as SafetyNet or DeviceCheck, then no additional risk points might be added. If the device fingerprint is new but passes hardware attestation, 15 points might be added. In cases where hardware attestation fails or suggests a spoofed environment, a higher risk value—such as 40 points—might be added to the score.

Another factor that may contribute to the score is the Historical Behavior Score. If the authentication attempt originates from a familiar IP address or geographic location with low geo-velocity, no points may be added. However, if geo-velocity is high—such as an attempt from a different country shortly after the previous session—25 points might be added.

Additionally, an Anomaly Signal Score may be considered. If the user's phone number (MSISDN) has exceeded predefined rate limits for token requests (e.g., more than five attempts within a 15-minute window), 10 points might be added. Furthermore, if the submitted token is detected as a replay attempt by matching a hash in a persistent database, a significant penalty of 60 points may be applied.

Once all signals are evaluated, the system could calculate the Overall Risk Score as the sum of the individual scores from each signal. For example, if a user has a new device that passes attestation (+15 points) and a SIM change occurred within the last 24 hours (+50 points), the Overall Risk Score might total 65.

The authentication decision may then be determined by comparing the Overall Risk Score to defined thresholds. If the score falls between 0 and 19, the user may be deemed low risk, and the authentication approved with a “PASS” outcome. If the score is between 20 and 49, representing medium risk, the user might be challenged with an additional security measure, such as a CAPTCHA, before authentication can proceed. If the score is 50 or higher, indicating high risk, the authentication may be rejected with a “FAIL” outcome, and the system could either initiate a step-up authentication procedure or block the attempt entirely.

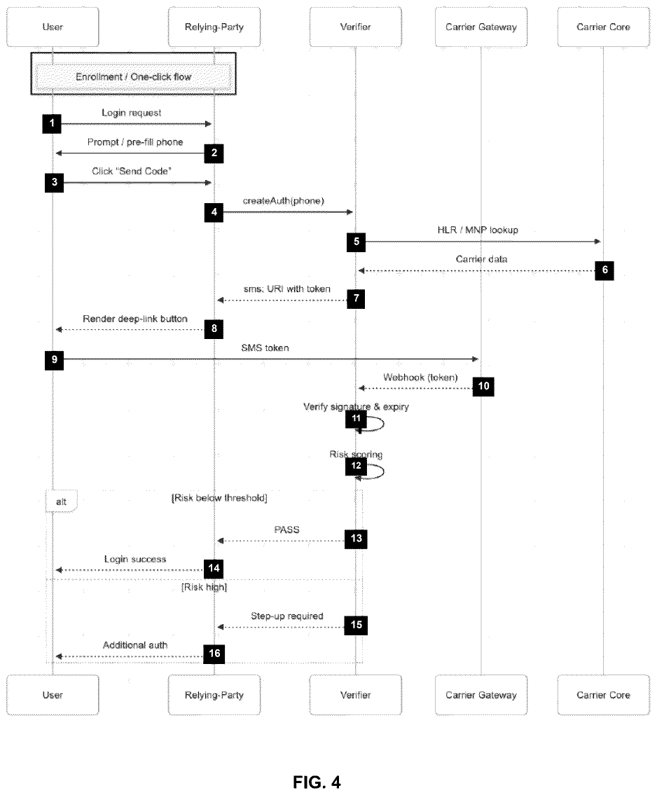

FIG. 4 illustrates a message-sequence chart 400 for enrollment and for subsequent authentications, in accordance with an embodiment of the disclosure. FIG. 4 captures the “one-click” flow in which a user authenticates by sending a stateless, signed token via SMS, with the following key steps: 1. The user initiates a login request to the relying party (RP) service. 2. The RP prompts the user to enter or confirm their phone number. 3. The user clicks “Send Code” to proceed with authentication. 4. The RP invokes the verifier service by calling a “createAuth” function with the user's phone number. 5. The verifier queries a carrier core service (e.g., HLR/MNP API) to retrieve carrier metadata, including carrier identity and SIM-change status. 6. Based on the returned carrier data, the verifier generates a signed token and returns a secure ‘sms:’ URI to the RP. 7. The RP renders a deep-link button for the user, pre-filled with the destination number and the token. 8. The user clicks the button, triggering the mobile device to send the signed token via SMS to the carrier gateway. 9. The carrier gateway receives the SMS and invokes a webhook to deliver the token to the verifier. 10. The verifier validates the token's signature and expiry without requiring a session state. 11. The verifier performs risk scoring, incorporating device fingerprints and carrier data (e.g., SIM-swap indicators). 12. Based on the risk score: If the risk is below a threshold, the verifier returns a “PASS” decision. If the risk is high, the verifier returns a “step-up required” decision. 13. The RP notifies the user of either a successful login or prompts them for additional authentication. This flow allows secure, low-friction MFA by enabling the user to originate the authentication message, thereby reducing SMS-pumping fraud vectors, preventing OTP replay, and enabling enhanced risk analysis without relying on forward-SMS delivery.

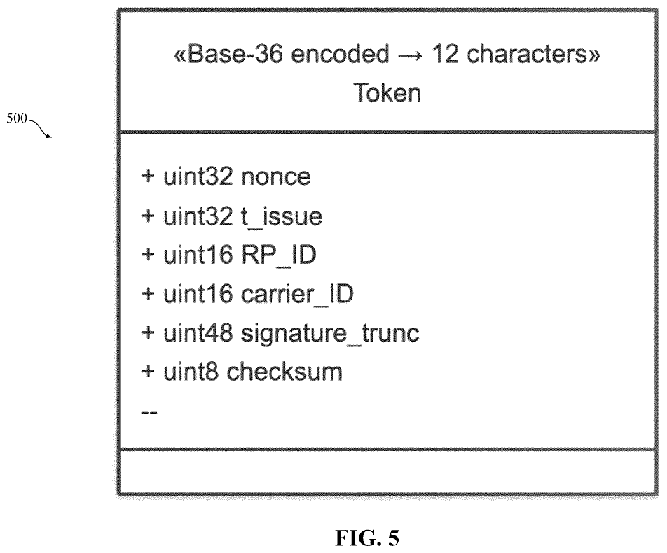

FIG. 5 illustrates a structure 500 of the stateless code (header, payload, signature, checksum), in accordance with an embodiment of the disclosure. The present system and method encode the signed token as a base-36 alphanumeric code of 12 or fewer characters, suitable for manual entry by the user.

```
classDiagram
  class Token {
    + uint32 nonce
    + uint32 t_issue
    + uint16 RP_ID
    + uint16 carrier_ID
    + uint48 signature_trunc
    + uint8 checksum
    --
    <<Base-36 encoded → 12 characters>>
  }
```

The following example outlines one possible method for token generation and signing, consistent with the structure illustrated in FIG. 5. Other cryptographic primitives and data serialization formats may also be used to achieve the same result.

In a first step, Data Aggregation, the verifier microservice may be configured to collect a defined set of data fields necessary for further processing and verification. The data aggregation process includes generating a cryptographically secure 32-bit random nonce, which serves as a unique and unpredictable value to ensure the integrity and freshness of the transaction. Additionally, a 32-bit Unix timestamp is captured to represent the issuance time, denoted as t_issue, which marks the exact moment the verification request was initiated.

The verifier microservice also retrieves a 16-bit identifier corresponding to the relying party (RP_ID), which uniquely identifies the application or service requesting the verification. Furthermore, a 16-bit identifier for the user's mobile carrier (carrier ID) is obtained. This carrier_ID is acquired through a query to a carrier information service, which resolves the user's mobile network provider based on the available subscriber or session data. The aggregation of these data fields enables the verifier to construct a secure and context-rich verification request.

In a second step, Message Payload Construction, the collected data fields are serialized into a fixed-width binary message payload to help ensure consistency. In this example, the payload is 12 bytes long, constructed by concatenating the fields in a predefined order (e.g., big-endian byte order): [nonce (4 bytes)]+[t_issue (4 bytes)]+[RP_ID (2 bytes)]+[carrier_ID (2 bytes)].

In a third step, Signature Generation, the 12-byte message payload is cryptographically signed using the verifier's private key. The system uses a hash-based signature algorithm, such as HMAC-SHA256, with a secret key known only to the verifier service. The full HMAC-SHA256 hash (32 bytes) is computed over the 12-byte payload. To create a compact token, the signature is truncated. For example, the first 48 bits (6 bytes) of the computed hash are taken to be the signature_trunc. This provides 48 bits of security against forgery, which may be sufficient for a short-lived token.

In a final step, Final Token Assembly and Encoding, the system assembles the final binary token by concatenating the original payload, the truncated signature, and an 8-bit checksum (e.g., a CRC8 of the preceding 18 bytes) to ensure data integrity. The total binary length in this example is 19 bytes (12-byte payload+6-byte signature+1-byte checksum).

This 19-byte binary structure is then encoded into a user-friendly format. Using Base-36 encoding, the structure is converted into a short alphanumeric string, designed to be 12 or fewer characters. The resulting string is the stateless token transmitted to the user's client device.

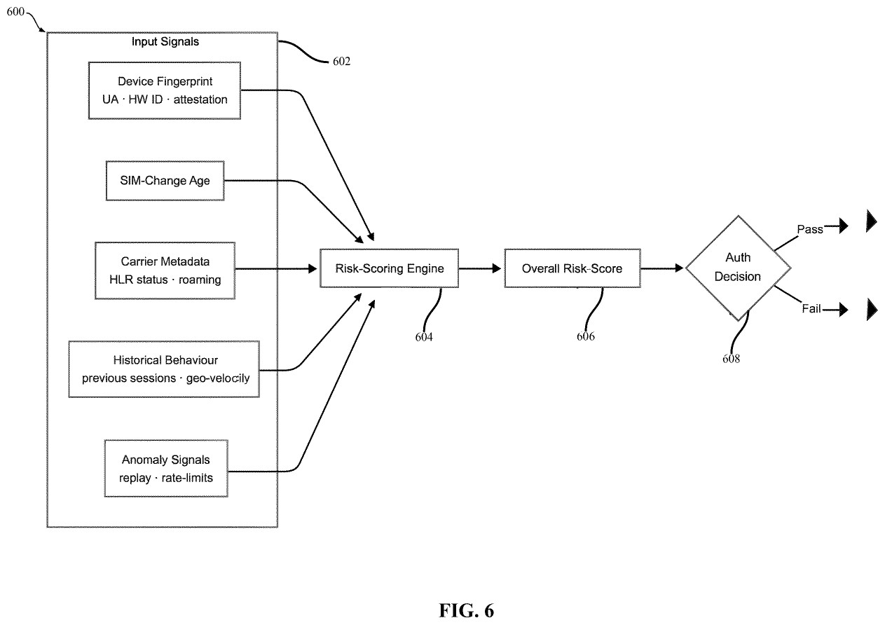

FIG. 6 illustrates a flow chart 600 of a risk-scoring engine combining carrier signals and device-fingerprint vectors, in accordance with an embodiment of the disclosure. FIG. 6 illustrates the risk-scoring engine used to enhance the security of a reverse-SMS multi-factor authentication (MFA) system. This figure shows how multiple types of input signals are processed by a risk-scoring engine to produce an overall risk score that informs the authentication decision. The method includes various components such as input signals 602, risk-scoring engine 604, and authentication decision 606.

Input signals 602: A variety of real-time and historical data points are ingested into the risk-scoring engine, including: A) Device Fingerprint: Information such as user-agent (UA), hardware ID, and attestation data (e.g., SafetyNet or WebAuthn) that help confirm device authenticity. B) SIM-Change Age: Metadata reflecting the recency of SIM card replacement or number porting events. C) Carrier Metadata: Network-level data such as Home Location Register (HLR) status and roaming indicators obtained via mobile carrier APIs. D) Historical Behavior: Behavioral data such as prior successful sessions and geo-velocity (location changes over time). E) Anomaly Signals: Patterns such as token replay attempts and SMS rate-limit violations.

Risk-scoring engine 604: These diverse input signals are aggregated and processed to compute a composite overall risk score. The engine may assign different weights to each signal based on policy or empirical fraud patterns.

Authentication decision 606: The computed risk score is compared against predefined thresholds to determine whether the authentication request is: Approved (Pass)—if the risk score falls below the acceptance threshold; or rejected or escalated (Fail)—if the risk score exceeds the rejection threshold, potentially triggering step-up authentication mechanisms.

This risk-scoring mechanism ensures that the authentication process remains both secure and adaptive, dynamically responding to high-risk signals while allowing low-friction access for trusted users.

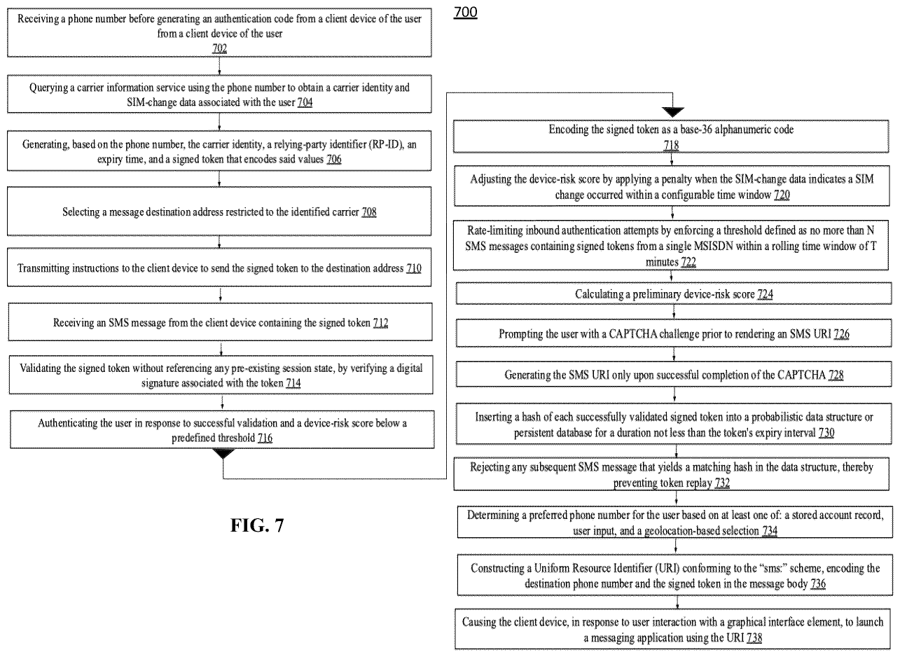

FIG. 7 illustrates a flowchart that illustrates a computer-implemented method 700 for authenticating a user of a relying-party (RP) service, in accordance with an embodiment of the disclosure. FIG. 7 is explained in conjunction with elements from FIG. 1-FIG. 6. At 702, the computer-implemented method 700 includes a step of receiving, by a computer, a phone number before generating an authentication code from a client device of the user from a client device of the user. At 704, method 700 includes a step of querying, by the computer, a carrier information service using the phone number to obtain a carrier identity and SIM-change data associated with the user. At 706, method 700 includes a step of generating, by the computer, based on the phone number, the carrier identity, a relying-party identifier (RP-ID), an expiry time, and a signed token (stateless token) that encodes the values. At 708, method 700 includes a step of selecting, by the computer, a message destination address restricted to the identified carrier. At 710, method 700 includes a step of transmitting, by the computer, instructions to the client device to send the signed token to the destination address. At 712, method 700 includes a step of receiving, by the computer, an SMS message from the client device containing the signed token. At 714, method 700 includes a step of validating, by the computer, the signed token without referencing any pre-existing session state, by verifying a digital signature associated with the token. At 716, method 700 includes a step of authenticating, by the computer, the user in response to successful validation and a device-risk score below a predefined threshold.

In an embodiment, at step 718, method 700 includes a step of encoding, by the computer, the signed token as a base-36 alphanumeric code of 12 or fewer characters, suitable for manual entry by the user. At step 720, method 700 includes a step of adjusting, by the computer, the device-risk score by applying a penalty when the SIM-change data indicates a SIM change occurred within a configurable time window. At step 722, method 700 includes a step of rate-limiting, by the computer, inbound authentication attempts by enforcing a threshold defined as no more than N SMS messages containing signed tokens from a single MSISDN within a rolling time window of t minutes, wherein n and t are dynamically configurable. At step 724, method 700 includes a step of calculating, by the computer, a preliminary device-risk score. At step 726, when the preliminary score lies between a first threshold and a second threshold (higher), prompted, by the computer, the user with a CAPTCHA challenge before rendering an SMS URI. At step 728, method 700 includes a step of generating, by the computer, the SMS URI only upon successful completion of the CAPTCHA. At step 730, method 700 includes a step of inserting, by the computer, a hash of each successfully validated signed token into a probabilistic data structure or persistent database for a duration not less than the token's expiry interval. At step 732, the method includes rejecting, by the computer, any subsequent SMS message that yields a matching hash in the data structure, thereby preventing token replay.

At step 734, method 700 includes a step of determining, by the computer, a preferred phone number for the user based on at least one of: a stored account record, user input, or a geolocation-based selection. At step 736, method 700 includes a step of constructing, by the computer, a Uniform Resource Identifier (URI) conforming to the “sms:” scheme, encoding the destination phone number and the signed token in the message body. At step 738, method 700 includes a step of causing the client device, in response to user interaction with a graphical interface element, to launch a messaging application using the URI.

In some embodiments, the method further includes a step of upon failure of validation or excessive device-risk score, providing, by the computer, an alternative authentication method selected from: delivery of a time-based one-time password (TOTP) to a registered authenticator application; delivery of a voice call to the MSISDN containing a voice-spoken OTP; or issuance of a single-use recovery link to a pre-verified secondary email address.

In some embodiments, the method further includes a step of inserting, by the computer, into the URI the carrier-restricted destination address to enable toll-fraud mitigation alongside a one-click message launch.

In some embodiments, the message destination address is a Home Network Identifier (HNI)-restricted shortcode routable only within the user's home carrier network.

In some embodiments, the signed token is generated using a hash-based stateless signature algorithm that provides at least 80 bits of cryptographic security.

In some embodiments, the device-risk score is computed using one or more of: browser fingerprint data; hardware attestation signals; and metadata bound into the signed token.

In some embodiments, upon successful validation of the signed token, an audit record is generated that excludes the user's phone number.

In some embodiments, rate-limiting further includes aggregating message counts by carrier identifier and destination address, and rejecting any SMS message that would exceed any of: (a) a per-MSISDN limit; (b) a per-carrier limit; or (c) a per-destination address limit.

In some embodiments, the signed token further comprises the RP-ID, and the validation step includes comparing the RP-ID in the token to an RP-ID provided with the authentication request and rejecting the token when the identifiers do not match.

In some embodiments, the signed token further includes a monotonically increasing counter associated with the MSISDN, and the validation step includes verifying that the counter is greater than the most recently accepted counter value for that MSISDN.

In some embodiments, the client device transmits the SMS message automatically without additional user interaction, when permitted by the client device's operating system policies.

According to one or more embodiments of the disclosure, a computer program product for authenticating a user of a relying-party (RP) service is described. The computer-executable program code instructions comprising program code instructions to: receive a phone number before generating an authentication code from a client device of the user from a client device of the user; query a carrier information service using the phone number to obtain a carrier identity and SIM-change data associated with the user; generate based on the phone number, the carrier identity, a relying-party identifier (RP-ID), an expiry time, a signed token that encodes the values; select a message destination address restricted to the identified carrier; transmit instructions to the client device to send the signed token to the destination address; receive an SMS message from the client device containing the signed token; validate the signed token without referencing any pre-existing session state, by verifying a digital signature associated with the token; and authenticate the user in response to successful validation and a device-risk score below a predefined threshold.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A computer system, comprising:
a memory to store machine-readable instructions pertaining to a user authentication; and
a processor set configured to:
receive a phone number before generating an authentication code from a client device of the user;
query a carrier information service using the phone number to obtain a carrier identity and SIM-change data associated with the user;
generate based on the phone number, the carrier identity, a relying-party identifier (RP-ID), an expiry time, and a signed token that encodes the values;
select a message destination address restricted to the identified carrier;
transmit instructions to the client device to send the signed token to the destination address;
receive an SMS message from the client device containing the signed token;
validate the signed token without referencing any pre-existing session state, by verifying a digital signature associated with the token;
encode the signed token as a base-36 alphanumeric code of 12 or fewer characters; and
authenticate the user in response to successful validation and a device-risk score below a predefined threshold.

2. The computer system of claim 1, wherein the processor set is configured to adjust the device-risk score by applying a penalty when the SIM-change data indicates a SIM change occurred within a configurable time window.

3. The computer system of claim 1, wherein the processor set is configured to rate-limit inbound authentication attempts by enforcing a threshold defined as no more than N SMS messages containing signed tokens from a single MSISDN within a rolling time window of T minutes.

4. The computer system of claim 1, wherein the processor set is configured to:
calculate a preliminary device-risk score;
when the preliminary score lies between a first threshold and a second threshold, prompt the user with a CAPTCHA challenge before rendering an SMS URI; and
generate the SMS URI only upon successful completion of the CAPTCHA.

5. The computer system of claim 1, wherein the processor set is configured to:
insert a hash of each successfully validated signed token into a probabilistic data structure or persistent database for a duration not less than the token's expiry interval; and
reject any subsequent SMS message that yields a matching hash in the data structure, thereby preventing token replay.

6. The computer system of claim 1, wherein the processor set is configured to:
determine a preferred phone number for the user based on at least one of: a stored account record, user input, and a geolocation-based selection;
construct a Uniform Resource Identifier (URI) conforming to the “sms:” scheme, encoding the destination phone number and the signed token in the message body; and
cause the client device in response to user interaction with a graphical interface element, to launch a messaging application using the URI.

7. The computer system of claim 1, wherein the message destination address is a Home Network Identifier (HNI)-restricted shortcode routable only within the user's home carrier network.

8. The computer system of claim 1, wherein the signed token is generated using a hash-based stateless signature algorithm that provides at least 80 bits of cryptographic security.

9. The computer system of claim 1, wherein the device-risk score is computed using one or more of: browser fingerprint data; hardware attestation signals; and metadata bound into the signed token.

10. A computer-implemented method for authenticating a user of a relying-party (RP) service, comprising:
receiving, by a computer, a phone number before generating an authentication code from a client device of the user;
querying, by the computer, a carrier information service using the phone number to obtain a carrier identity and SIM-change data associated with the user;
generating, by the computer, based on the phone number, the carrier identity, a relying-party identifier (RP-ID), an expiry time, and a signed token that encodes the values;
selecting, by the computer, a message destination address restricted to the identified carrier;
transmitting, by the computer, instructions to the client device to send the signed token to the destination address;
receiving, by the computer, an SMS message from the client device containing the signed token;
validating, by the computer, the signed token without referencing any pre-existing session state, by verifying a digital signature associated with the token;
encoding, by the computer, the signed token as a base-36 alphanumeric code of 12 or fewer characters; and
authenticating, by the computer, the user in response to successful validation and a device-risk score below a predefined threshold.

11. The method of claim 10, further comprising encoding, by the computer, the signed token as a base-36 alphanumeric code.

12. The method of claim 10, further comprising adjusting, by the computer, the device-risk score by applying a penalty when the SIM-change data indicates a SIM change occurred within a configurable time window.

13. The method of claim 10, further comprising rate-limiting, by the computer, inbound authentication attempts by enforcing a threshold defined as no more than N SMS messages containing signed tokens from a single MSISDN within a rolling time window of T minutes, wherein N and T are dynamically configurable.

14. The method of claim 10, further comprising:
calculating, by the computer, a preliminary device-risk score;
when the preliminary score lies between a first threshold and a second threshold, prompting, by the computer, the user with a CAPTCHA challenge before rendering an SMS URI; and
generating, by the computer, the SMS URI only upon successful completion of the CAPTCHA.

15. The method of claim 10, further comprising:
inserting, by the computer, a hash of each successfully validated signed token into a probabilistic data structure or persistent database for a duration not less than the token's expiry interval; and
rejecting, by the computer, any subsequent SMS message that yields a matching hash in the data structure, thereby preventing token replay.

16. The method of claim 10, further comprising:
determining, by the computer, a preferred phone number for the user based on at least one of: a stored account record, a user input, and a geolocation-based selection;
constructing, by the computer, a Uniform Resource Identifier (URI) conforming to the “sms:” scheme, encoding the destination phone number and the signed token in the message body; and
causing the client device, in response to user interaction with a graphical interface element, to launch a messaging application using the URI.

17. A computer program product comprising at least one non-transitory computer-readable storage medium having computer-executable program code instructions stored therein, the computer-executable program code instructions comprising program code instructions to:
receive a phone number before generating an authentication code from a client device of the user;
query a carrier information service using the phone number to obtain a carrier identity and SIM-change data associated with the user;
generate based on the phone number, the carrier identity, a relying-party identifier (RP-ID), an expiry time, and a signed token that encodes the values;
select a message destination address restricted to the identified carrier;
transmit instructions to the client device to send the signed token to the destination address;
receive an SMS message from the client device containing the signed token;
validate the signed token without referencing any pre-existing session state, by verifying a digital signature associated with the token;
encode the signed token as a base-36 alphanumeric code of 12 or fewer characters; and
authenticate the user in response to successful validation and a device-risk score below a predefined threshold.
